(19) United States
(12) Patent Application Publication
(10) Pub. No.: US 2021/0393058 A1
(43) Pub. Date: Dec. 23, 2021

(54) HEADBAND PILLOW

(71) Applicant: Susan Alcedo, Arlington, TX (US)

(72) Inventor: Susan Alcedo, Arlington, TX (US)

(21) Appl. No.: 16/905,850

(22) Filed: Jun. 18, 2020

(51) Int. Cl. A47G 9/10; A61G 7/07; A62B 23/02; H04R 1/02

(52) U.S. Cl. CPC A47G 9/1045; A61G 7/072; A47G 2009/006; H04R 1/028; A62B 23/025

(57) ABSTRACT

Various aspects of the present disclosure are directed to an adjustable pillow for eliminating physical contact between one or more portions of a user's skin, face and/or body part(s), and a support surface upon which the adjustable pillow rests. The adjustable pillow is attached to or otherwise integrated into a headband to maintain specific placement of the adjustable pillow relative to a user's head, face, etc.

### BACKGROUND

### a. Field

The instant disclosure relates to head and neck pillows, among other types of pillows.

### b. Background Art

Pillows have been used for various purposes for thousands of years to support the body and/or for decoration. Some pillows have a specific shape and use.

The foregoing discussion is intended only to illustrate the present field and should not be taken as a disavowal of claim scope.

### BRIEF SUMMARY

Various embodiments of the present disclosure are directed to an adjustable pillow for eliminating physical contact between one or more portions of a user's skin, face, and/or body part(s), and a support surface upon which the pillow rests. The adjustable pillow is attached to or otherwise integrated into a headband to maintain specific placement of the adjustable pillow relative to a user's head, neck, etc.

In one example embodiment, a headband pillow is disclosed including one or more pillows, a pillow portion including first and second end portions, a headband portion including third and fourth end portions. The pillow portion is coupled with the one or more pillows, and the headband portion circumferentially encompasses a portion of a user. The first end portion of the pillow portion and the third end portion of the headband portion are coupled to one another, and the second end portion of the pillow portion and the fourth end portion of the head band portion are coupled to one another to form an annulus shape. The headband pillow prevents contact with a region of the user. In more specific embodiments, the pillow portion further includes a pouch and a flap. The pouch receives the one or more pillows, and the flap in conjunction with the pouch fully encompasses the one or more pillows and secures the one or more pillows to the pillow portion.

The foregoing and other aspects, features, details, utilities, and advantages of the present disclosure will be apparent from reading the following description and claims, and from reviewing the accompanying drawings.

### BRIEF DESCRIPTION OF THE DRAWINGS

Various example embodiments may be more completely understood in consideration of the following detailed description in connection with the accompanying drawings, in which:

FIG. 1A is a front view of a headband pillow, consistent with various embodiments of the present disclosure;

FIG. 1B is a perspective front of the headband pillow of FIG. 1A, consistent with various embodiments of the present disclosure;

FIG. 1C is a side view of the headband pillow of FIG. 1A, consistent with various embodiments of the present disclosure;

FIG. 1D is a perspective back view of the headband pillow of FIG. 1A, consistent with various embodiments of the present disclosure; and

FIG. 2 is a back view of a headband pillow, consistent with various embodiments of the present disclosure.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION OF EMBODIMENTS

Various aspects of the present disclosure are directed to an adjustable pillow for eliminating physical contact between one or more portions of a user's skin, face, and/or body part(s), and a support surface upon which the adjustable pillow rests. In various embodiments of the present disclosure, a pillow is attached to or otherwise integrated into a headband to maintain specific placement of the pillow relative to a user's head, etc.

Applications for an adjustable pillow in accordance with one or more of the embodiments presented herein include both consumer and medical usage. As one example, the headband pillow may elevate the face away from a support surface (e.g., bed) to prevent and/or reduce the occurrence of wrinkling—especially to regions of the face prone to developing lateral canthal lines (commonly referred to as “crow's feet”). It has been discovered that the side of a user's face where their head more commonly contacts their pillow may be more susceptible to developing “crow's feet.” This is due to compression and any lateral tension between the user's facial skin and the pillow. Aspects of the present disclosure help mitigate such undesirable contact by concentrating the location of the pillow on portions of the user's head more capable of transmitting the weight of the user's head/neck to the support surface below the pillow without undue damage. Additional benefits of the headband pillow may include reduction in forehead wrinkles and lines around the mouth, protecting the user's eyes, and for those inevitable short nights where maintaining your make-up for the morning is important.

Aspects of the headband pillow disclosed herein enhance adjustability, as well as conformance to various portions of the user's limbs, head, etc.—thereby facilitating precise placement of the pillow relative to one or more portions of a user's skin, face, and/or body parts where contact with a support surface is undesirable during rest. Moreover, as the pillow is coupled to a user via a headband, the pillow is less prone to dislodgment while the user is sleeping—where dislodgment of the pillow may be detrimental to a user's health/wellbeing.

Various headband pillow embodiments consistent with the present disclosure may be utilized for various beauty regimens. For example, when the headband pillow is used in relation to a user's head, the delicate and sensitive facial skin need not contact the pillow itself and/or a support surface of the pillow. Therefore, the unsightly “morning-wrinkles” and “creases” caused by pillow contact may be mitigated and in some cases avoided entirely. Where the headband pillow is used nightly over an extended period of time, age-lines may also be reduced.

Various embodiments of the present disclosure also provide the benefits of a traditional pillow, including aligning the spinal column by elevating the head relative to the rest of the body. Accordingly, aspects of the present disclosure may mitigate and/or relieve neck problems including pain and stiffness after sleeping.

Headband pillows consistent with the present disclosure also facilitate the use of various beauty aids. For example, where a user applies beauty creams, acne medication, make-up, or any type of facial product prior to resting, the headband pillow will mitigate the product from being rubbed off while the user is sleeping as a headband of the headband pillow maintains relative positioning of the pillow and the user's face to prevent transfer of the product onto the pillow itself and/or a support surface. By increasing total product absorption time, improved results may be experienced. Another embodiment of headband pillows, consistent with the present disclosure, reduce or eliminate contact between a user's face and grime, sweat, drool, etc, absorbed by a user's pillow (between cleanings of a user's bed linens). By reducing facial contact with such contaminants, facial blemishes, acne and other skin disorders may be reduced.

Various aspects of the present disclosure are directed to extending the life of eyelash extensions by minimizing rubbing with a pillow or support surface, thereby mitigating degradation of the glue which holds the eyelash extensions onto a user's eyelids.

Yet another object of the present invention is facilitating medical therapies. For example, elevating a limb to mitigate swelling associated with a knee injury, elbow, leg, etc, Another example use of the headband pillow is for orthopedic therapies—positioning a user's wrist/arm during rest to mitigate symptoms associated with carpal tunnel syndrome, or the like. Headband pillows consistent with the present disclosure may aid in elevating a user's face or otherwise preventing contact between the user's face and pillow/support surface after various medical procedures and surgeries (e.g., Botox or other cosmetic facial procedures, eye/dental/oral/nasal cavity/facial surgeries).

The headband pillow, consistent with various embodiments of the present disclosure, may also be used to position and protect an incision where a user's body is receiving one or more tubes (e.g., a user's esophagus). In yet another embodiment, the headband pillow may facilitate user's sleeping in their hearing aids, headphones, or earplugs, where force being transferred from a pillow/support surface through the hearing aid over an extended period of time would otherwise cause discomfort.

Still another benefit of the present invention is protecting a surgical site, a scrape, a sore, blister etc. Where a user may have undergone a facial surgery, brain surgery, etc., the headband pillow may be positioned outside of a region of the face impacted by the surgery, elevate the effected region of the user from a support surface, and maintain the relative position of the pillow to the head while the user is unconscious or recovering. The surgically affected portion of the face benefits from improved circulation and the extended exposure to air may expedite the natural healing process.

While various embodiments of the present disclosure are directed to an implementation of the invention for use around a head of a user, various other embodiments of the headband pillow may be implemented in which a pillow and associated “headband” may be of a shape and size that can easily fit a user's leg, arm, torso, etc. It is to be understood that while various example embodiments of the invention disclosed herein refers to a “headband,” the invention is not to be limited to uses specific to only one's head. To the contrary, and as discussed in various embodiments herein, the (head)band may be coupled to a user's leg, arm, torso, etc.

While some embodiments of the present disclosure are directed to the use of a single pillow within the headband pillow, various other embodiments may utilize one or more pillows, or a combination of one or more headband pillows consistent with the present disclosure.

In some more specific embodiments of a headband pillow, additional features may be integrated into the pillow. For example, a small compartment may be provided within the pillow for containment of one or more audio device within the headband (e.g., a Bluetooth speaker). In such an embodiment, the audio speakers may be permanently or temporarily affixed to (or within) the headband pillow.

Yet another advantage of a headband pillow consistent with one or more of the various embodiments disclosed herein include ease of use while traveling or the like. As the pillow is coupled to a user via the headband, the size of the pillow may be greatly reduced in size as a tossing-and-turning user will not roll off the pillow. This is particularly beneficial as the overall size

In one embodiment of the present disclosure a headband may be removably attached to the pillow via Velcro® (or other removable coupling means). In some embodiments. Velcro® (or other coupling means) may also be utilized to adjust a circumference of the headband pillow to a particular user.

In some specific embodiments, the pillow may be 4″ in height, 6″ in width, and 2″ in depth. The pillow being (removably) coupled to a headband at least partially comprising elastic to facilitate coupling of the pillow and headband to body parts with varying circumferences. By virtue of being removable coupled to the headband, the pillow may be adjusted in one or more of six degrees of freedom relative to the headband. In yet other embodiments, the pillow may be non-detachable from the headband, and the adjustability of the pillow is by virtue of adjustment of the band relative to the user's face or body part it is attached to. In some embodiments of the present disclosure, the pillow may be coupled to the headband via a pocket or pouch in the band itself. In such an embodiment, when not being used as a pillow the pillow may be removed from the headband and the headband may be worn during exercise, as a fashion accessory, etc.

In one specific embodiment of the present disclosure, the headband pillow includes a headband and a pillow where the headband is designed to be worn around a portion of the head and the pillow is positionable to cushion various locations of the head etc. Details of the various embodiments of the present disclosure are described in more detail below with specific reference to the figures.

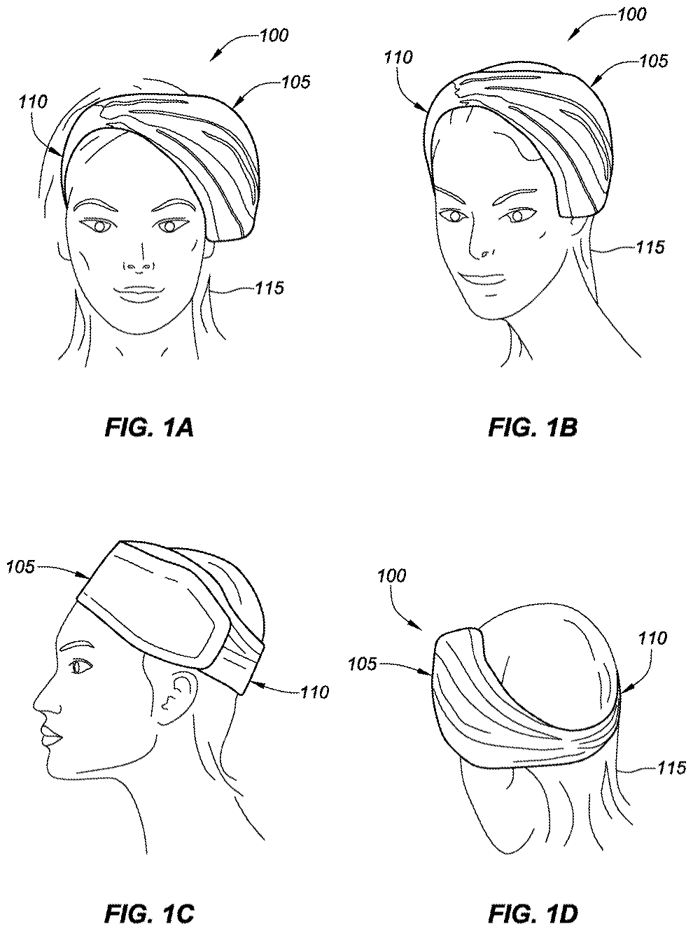

FIGS. 1A-D illustrate various views of a headband pillow 100 on a user's head 115, consistent with various embodiments of the present disclosure. The headband pillow 100 includes a pillow portion 105 and a headband portion 110. In the present embodiment, the pillow portion 105 extends approximately 50% about the circumference of the headband pillow 100, and the headband portion 110 extends approximately the remaining 50% about the circumference of the headband pillow 100.

As shown in FIGS. 1A-D, the pillow portion 105 of the headband pillow 100 is positioned with a left offset relative to the user's face. Where the user rests on their left side, the pillow portion 105 contacts a support surface and maintains the left side of the user's head 115 and left ear off of the support surface. Importantly, as the headband pillow 100 is coupled to the user's head 115, tossing-and-turning of the user during rest will minimally disturb the relative position of the headband pillow 100 relative to the user's head 115. Accordingly, where the user alternates between sleeping on their back and their left side, when sleeping on their back the headband pillow 100 does not disturb their sleep, and when the user returns to their left side the headband pillow 100 remains in place to contact a support surface and maintain the left side of the user's head 115 and left ear off of the support surface.

Though the present embodiment illustrates the headband pillow 100 offset to the left of a user's face, various radial positions of the pillow portion 105 relative to the user's head may be implemented. For example, the pillow portion may be directly aligned with a user's face to protect a user's nose during rest. Moreover, the headband pillow 100 need not be coupled to the user's head, let alone the user's forehead. For example, the headband pillow 100 may be implemented around a user's arm, leg, etc.

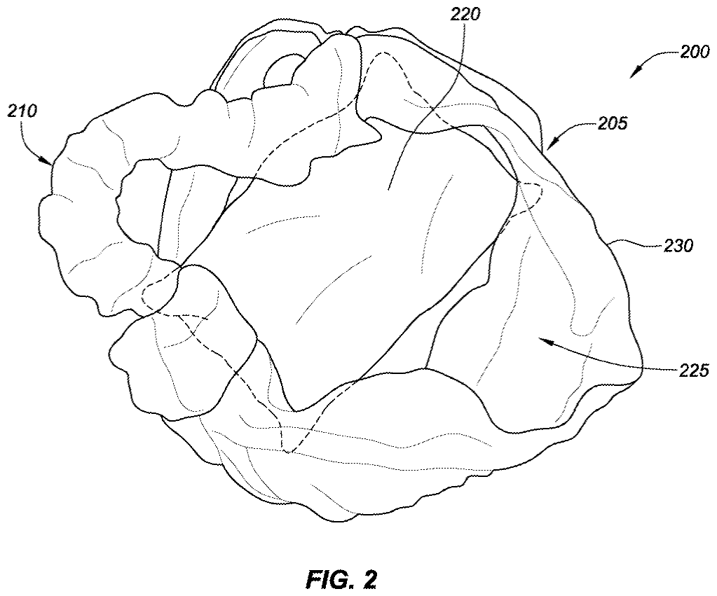

As discussed in more detail below with respect to FIG. 2, which is a back view of a headband pillow 200, a pillow 220 of the pillow portion 205 may be removeable to facilitate use of the headband pillow 200 as a headband during active periods of the user. Moreover, various other pillows of differing shapes and sizes may be inserted into the pillow portion 205 to customize the headband pillow 200 for a specific application. While various embodiments of the headband pillow 200 may utilize Velcro®, or other coupling means well known in the art, to couple the pillow 220 to the headband pillow 200, FIG. 2 utilizes a pouch 225 within the pillow portion 205 to couple the pillow 220 to the headband pillow 200 during use. To access the pillow 220, a flap 230 of the pouch 225 is opened, and returned once a new pillow 220 or the original pillow 220 is resituated as desired by the user. In some more specific embodiments, the flap 230 may utilize Velcro®, button, snaps, etc. to further secure itself to the pouch 225 and thereby maintain the pillow 220 within the pouch.

In some specific embodiments of the present disclosure, elastic may be utilized throughout the headband pillow to facilitate adjustment and a secure fit of the pillow to various users, and user's heads, limbs, etc. of various circumferences. In one embodiment, the elastic may extend along an entire circumference of the headband pillow. In other embodiments, the elastic may be limited to a headband portion 210 and not extend through the pillow portion 205. In yet other embodiments, the headband pillow may not be continuous and on either side of the pillow portion may be first and second respective headband portions with ends. Each end of the first and second headband portions may include a mechanism (or a portion of a mechanism) to facilitate adjustably coupling the first and second headband portion ends to each other. For example, the coupling may utilize a hook and loop fastener system, hook/loop tape closure, a buckle closure, mating Velcro® portions, etc.

Various headband pillows consistent with the present disclosure may include a plurality of locations and/or pouches for inserting one or more pillows of various shapes and sizes. For example, the headband pillow may comprise a headband portion which extends about an entire circumference of the headband pillow and includes at least one elastic band therein to facilitate desired conformance to various circumferences. Along an outer side of the headband portion, one or more pouches may be evenly spaced about the circumference of the headband (or unevenly distributed), for customization of pillow configurations for various applications. For example, where a user has recently undergone a surgical procedure to the face a user may place a headband pillow around their forehead and cranium including a thick center pillow aligned with their nose and lesser thickness pillows on either side of the center pillow to prevent contact during rest to the entirety of the user's face (regardless of the user's orientation at rest).

In some applications, a headband pillow consistent with the present disclosure may protect the user's face while they rest on their left side—the weight of the user's head being transmitted to the support surface via the headband pillow. Such a system may be particularly useful, for example, while flying. In such an application, the support structure may be the plane's fuselage (where the user is seated in a window seat), or any airplane seat where the user is rotated in their seat to rest the side of their head on the headrest (acting as the support structure). Where the support surface is the fuselage, at least a portion of the weight of a user's head may be transmitted through the headband pillow to the fuselage, helping to maintain proper alignment of the user's spinal cord to mitigate back-pain typically associated with resting on an airplane. Various other applications of the headband pillow may be found with respect to various forms of travel (e.g., plane, train, automobile, etc.).

In some specific applications of a headband pillow consistent with the present disclosure, for example where a user has experienced trauma on the left side of their face, the headband pillow may be radially offset to the left side of the user's face to prevent contact between the user's face and a support surface during rest.

In various specific embodiments of the headband pillow consistent with the present disclosure, the pillow may be non-removable from the headband. The headband pillow in such an embodiment consisting of a unitary structure.

In some specific embodiments, a pillow of a headband pillow may be removably coupled to the headband via a pouch within a pillow portion. The pouch consisting of pleating which facilitates expansion of the pouch for various pillow sizes and shapes; more specifically, oversized pillows.

Headband pillows consistent with the present disclosure may have an outer layer that comprise microfiber, cotton, spandex, neoprene, silk and combinations thereof. An underlaying structure comprising elastic to facilitate precise fit to a user. In various embodiments of the present disclosure, the headband pillow consists of one or more washable fabrics (well known in the art). The washable fabrics may include microfiber, cotton, spandex, neoprene, and silk.

In various applications of the headband pillow, the pillow may be removed and used as a facial covering over the eyes, mouth, and/or nose. In one particular embodiment, the headband pillow may be utilized as a mask over the mouth and nose to mitigate ingestion of particles into the user's respiratory system.

In some applications of the headband pillow, the user may utilize the headband pillow during rest and/or relaxation (e.g., sunbathing, television viewing, etc.).

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A headband pillow comprising:
one or more pillows;
a pillow portion including first and second end portions, the pillow portion configured and arranged to couple with the one or more pillows;
a headband portion including third and fourth end portions, and configured and arranged to circumferentially encompass a portion of a user;
wherein the first end portion of the pillow portion and the third end portion of the headband portion are coupled to one another, and the second end portion of the pillow portion and the fourth end portion of the head band portion are coupled to one another to form an annulus shape;
wherein the headband pillow is configured and arranged to prevent contact with a region of the user.

2. The headband pillow of claim 1, wherein the pillow portion further includes a pouch and a flap, the pouch configured and arranged to receive the one or more pillows, and the flap configured and arranged in conjunction with the pouch to fully encompass the one or more pillows and secure the one or more pillows to the pillow portion.

3. The headband pillow of claim 2, wherein the flap is secured to the pouch or pillow portion to further secure the one or more pillows to the pillow portion.

4. The headband pillow of claim 1, wherein the one or more pillows are configured and arranged to be coupled to and adjustable relative to the pillow portion, and the adjustment includes a variety of positions and orientations of the pillow portion and the one or more pillows relative to one another when coupled.

5. The headband pillow of claim 1, wherein the headband pillow is configured and arranged for beauty or health purposes.

6. The headband pillow of claim 1, wherein the headband pillow is further configured and arranged to prevent contact with a region of the user by making contact with a support surface during use by a user and being in close proximity to the region of the user.

7. The headband pillow of claim 6, wherein the support surface is a bed, and the region of the user is at least a portion of the user's face.

8. The headband pillow of claim 1, wherein the one or more pillows comprise a pliable resilient cushioning substance.

9. The headband pillow of claim 1, wherein the headband pillow consists of one or more of the following materials: microfiber, cotton, spandex, neoprene, and silk.

10. The headband pillow of claim 1, wherein the headband pillow is configured and arranged to function as a beauty aid by mitigating wrinkles and creases on a user's face.

11. The headband pillow of claim 1, wherein the headband pillow is configured and arranged to function as a therapeutic aid by protecting a user's face.

12. The headband pillow of claim 1, further including a storage compartment configured and arranged to hold an audio device.

13. The headband pillow of claim 1, wherein the headband portion is configured and arranged to expand and contract, facilitating coupling to users of various size.

14. The headband pillow of claim 1, wherein the headband pillow consists of one or more washable materials.

15. The headband pillow of claim 1, wherein the headband pillow is configured and arranged for use as a travel pillow.

16. The headband pillow of claim 1, wherein the headband pillow is configured and arranged for use as a mask over the mouth and nose to mitigate ingestion of particles into the user's respiratory system.

17. The headband pillow of claim 1, wherein the one or more pillows consist of non-absorbent material.
